(19) United States
(12) Patent Application Publication
(10) Pub. No.: US 2016/0064882 A1
(43) Pub. Date: Mar. 3, 2016

(54) Detachable Storage Device

(71) Applicant: GOLDEN VAST MACAO COMMERCIAL OFFSHORE LIMITED, HongKong (CN)

(72) Inventor: KwokFong WONG, HongKong (CN)

(21) Appl. No.: 14/827,633

(22) Filed: Aug. 17, 2015

(30) Foreign Application Priority Data
Aug. 29, 2014 (CN) 201420495833.5

(51) Int. Cl. H01R 27/02; H01R 13/66; H01R 12/70

(52) U.S. Cl. CPC H01R 27/02; H01R 12/7076; H01R 13/665

(57) ABSTRACT

A detachable storage device is disclosed in the invention. The detachable storage device comprises an upper cover, a USB interface, a SD card joint, a main circuit board, a SD card, a lower cover and a SD card cover. The upper cover is fixed with the lower cover, the USB interface is provided on one end of the snap-fit position of the upper cover with the lower cover. The SD card cover is pivotally connected on one end of the lower cover provided with the USB interface, the SD card which is fixed within the lower cover is provided at inner side of the SD card cover, and the SD card is clamped on a SD card fixing seat which is fixed on a lower side of the main circuit board within the lower cover, and the SD card joint is provided on the other end of the snap-fit position of the upper cover with the lower cover. The detachable storage device is designed simply and scientifically so that it is convenient in use and low-cost. The detachable storage device has the encryption function and can be used safely. Also, the SD card is detachable such that it is suitable for different users, and this is favorable to the product popularization.

### FIELD OF THE INVENTION

The present invention relates to the field of storage devices, and more particularly to a detachable storage device.

### DESCRIPTION OF THE RELATED ART

Generally the existing storage devices are configured as various structures and have different functions, and most of them have one or more of the following disadvantages:

(1) the structure is designed complicatedly and thus inconvenient in use;

(2) the single function can not meet the usage requirements;

(3) the high cost of production leads to the difficulty of popularization and application; and

(4) the safety performance is poor.

### SUMMARY OF THE INVENTION

One object of the invention is to provide a detachable storage device to overcome the above shortcomings of the prior art. In the invention, the detachable storage device is designed simply and scientifically so that it is convenient in use and low-cost. The detachable storage device has the encryption function and can be used safely. Also, the SD card is detachable such that it is suitable for different users, and this is favorable to the product popularization.

For the above design purposes, the invention utilizes the following technical solution:

A detachable storage device, comprising an upper cover, a USB interface, a SD card joint, a main circuit board, a SD card, a lower cover and a SD card cover. The upper cover is fixed with the lower cover, the USB interface is provided on one end of the snap-fit position of the upper cover with the lower cover, and the SD card cover is pivotally connected on one end of the lower cover provided with the USB interface. The SD card which is fixed within the lower cover is provided at inner side of the SD card cover, and the SD card is clamped on a SD card fixing seat which is fixed on a lower side of the main circuit board within the lower cover, and the SD card joint is provided on the other end of the snap-fit position of the upper cover with the lower cover

Preferably, the SD card joint is fixed on an upper side of a sliding block which is slidably connected on a SD card joint sliding seat, and the SD card joint sliding seat is fixed within the lower cover. A lower side of the sliding block extends through a sliding groove on the surface of the lower cover.

Preferably, a SD card joint spring is arranged between the sliding block and one end of the lower cover provided with the SD card joint. A buckle strip is provided on the sliding block, and a buckle groove is provided on the lower cover corresponding to the buckle strip.

More preferably, the USB interface is fixed on a lower side of the sliding block seat which is slidably connected on a USB interface fixing seat fastened or locked on the upper cover. A USB interface sliding block is fixed on an upper side of a lock catch cover body, and the USB interface sliding block extends through the USB interface fixing seat and extends out from a sliding groove provided on the surface of the upper cover.

Preferably, a locking seat is arranged between the USB interface fixing seat and the upper cover, and a groove is provided on the locking seat for locking the USB interface sliding block.

Preferably, a USB interface spring is arranged between the USB interface fixing seat and an inner side of one end of the upper cover away from the USB interface.

Due to the application of the above technical solution, the detachable storage device of the invention has the following advantages: the detachable storage device is designed simply and scientifically so that it is convenient in use and low-cost; the detachable storage device has the encryption function and can be used safely. Also, the SD card is detachable so that it is suitable for different users, and this is favorable to the product popularization.

### BRIEF DESCRIPTION OF THE DRAWINGS

FIG. 1 is a schematic view of a detachable storage device according to the invention;

FIG. 2 is an exploded view of the detachable storage device according to the invention.

wherein: 1. an upper cover; 2. a locking seat; 3. a USB interface fixing seat; 4. a USB interface sliding block; 5. a sliding block seat; 6. a USB interface; 7. a SD card joint; 8. a main circuit board; 9. a SD card joint sliding seat; 10. a SD card joint spring; 11. a SD card; 12. a SD card fixing seat; 13. a SD card spring fastener; 14. a sliding block; 15. a lower cover; 16. a SD card cover. 17. a USB interface spring.

### DESCRIPTION OF THE PREFERRED EMBODIMENTS

The preferred embodiments of present invention will be described hereinafter in more detail with reference to the accompanying drawings.

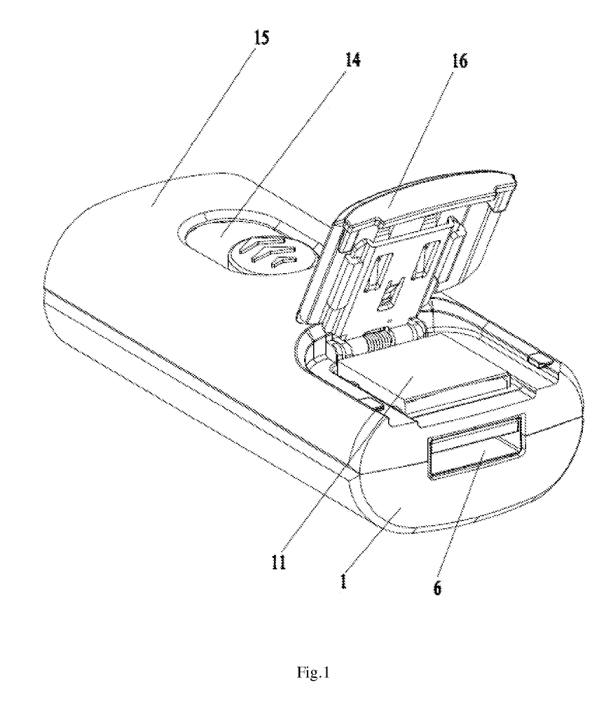

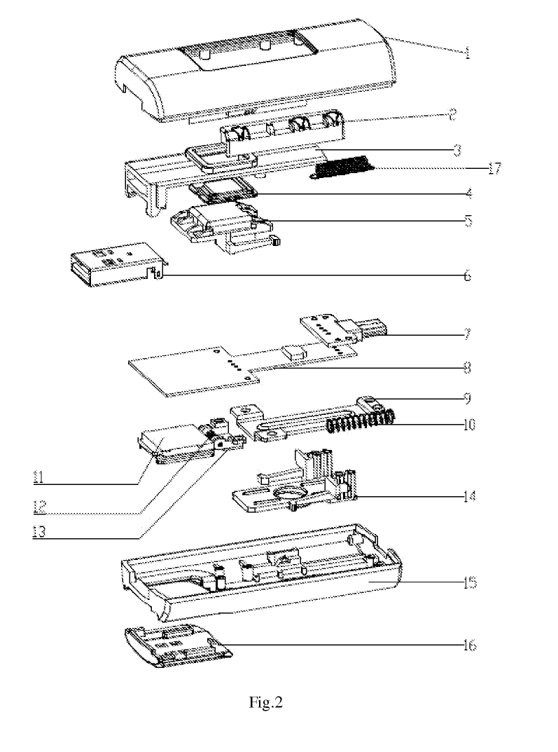

As shown in FIGS. 1-2, the detachable storage device comprises an upper cover 1, a USB interface 6, a SD card joint 7, a main circuit board 8, a SD card 11, a lower cover 15 and a SD card cover 16. The upper cover 1 is fastened to the lower cover 15, or locked with the lower cover 15 by a screw. A USB interface 6 is provided on one end of the snap-fit position of the upper cover 1 with the lower cover 15, and the USB interface 6 is telescopic freely from this end. A SD card cover 16 is pivotally connected on one end of the lower cover 15 provided with the USB interface 6, and the SD card cover 16 can be opened or closed on the lower cover 15. A SD card 11 which is fixed within the lower cover 15 is provided at inner side of the SD card cover 16, the SD card 11 is clamped on a SD card fixing seat 12 by a SD card spring fastener 13, and the SD card fixing seat 12 is fixed on the lower side of the main circuit board 8 fixed within the lower cover 15. In use, the SD card cover 16 is opened, such that the SD card 11 can be taken out and replaced after the SD card spring fastener 13 is opened, and this design is simple and convenient in use. A SD card joint 7 is provided at the other end of the snap-fit position of the upper cover 1 and the lower cover 15, and the SD card joint 7 is telescopic freely from this end.

The SD card joint 7 is fixed on the upper side of a sliding block 14 which is slidably connected on a SD card joint sliding seat 9. The sliding block 14 can be moved freely on the SD card joint sliding seat 9 which is fixed within the lower cover 15. The lower side of the sliding block 14 extends though a sliding groove provided on the surface of the lower cover 15. The sliding block 14 can slide on the sliding groove on the surface of the lower cover 15 and drive the SD card joint 7 to extend out from or draw back to the side end of the lower cover 15.

A SD card joint spring 10 is arranged between the sliding block 14 and the end of the lower cover 15 provided with the SD card joint 7. A buckle strip is provided on the sliding block 14, and a buckle groove is opened on the lower cover 15 corresponding to the buckle strip. In use, the sliding block 14 is pushed so that the buckle strip is clamped within the buckle groove, and the SD card joint 7 extends out from the side end of the lower cover 15, at this time, the sliding block 14 compresses the SD card joint spring 10, after the sliding block 14 is pressed down, the buckle strip is detached from the buckle groove, and the sliding block 14 moves under the pushing of the SD card joint spring 10, and drives the SD card joint 7 to draw back to the side end of the lower cover 15.

The USB interface 6 is fixed on the lower side of the sliding block seat 5 which is slidably connected on a USB interface fixing seat 3, and the USB interface fixing seat 3 is fastened or locked on the upper cover 1. The USB interface sliding block 4 is fixed on the upper side of the lock catch cover body. The USB interface sliding block 4 extends through the USB interface fixing seat 3 and extends out from the sliding groove provided on the upper cover 1. The USB interface sliding block 4 can slide on the sliding groove on the surface of the upper cover 1 and drives the sliding block seat 5 to slide along the USB interface fixing seat 3, thereby driving the USB interface 6 fixed on the lower side of sliding block seat 5 to extend out from or draws back to the side end of the upper cover 1.

A locking seat 2 is arranged between the USB interface fixing seat 3 and the upper cover 1, and a groove is opened on the locking seat 2 for locking the USB interface sliding block 4. When the USB interface 6 extends out from the side end of the upper cover 1, the USB interface sliding block 4 is fastened in the groove provided on one end of the locking seat 2. The USB interface sliding block 4 is detached from the groove on the locking seat 2 when it is pressed down.

A USB interface spring 17 is arranged between the USB interface fixing seat 3 and an inner side of the end of the upper cover 1 away from the USB interface 6. When the USB interface 6 draws back to the side end of the upper cover 1, it automatically draws back into the side end of the upper cover 1 under the pulling force of the USB interface spring 17.

As described above, the invention is illustrated in more detail in connection with preferred embodiments so that those skilled in the art can understand and implement the invention, however, it can not be deducted that the specific implementation of the invention is limited to these illustrations. Some simple deduction or replacements can be made within the scope of the invention by those skilled in the related art, without any creative work. Therefore, some improvements made by a person skilled in the art according to the disclosure of the invention should be covered by the protection scope of the invention.

What is claimed is:

1. A detachable storage device, comprising an upper cover, a USB interface, a SD card joint, a main circuit board, a SD card, a lower cover and a SD card cover, wherein the upper cover is fixed with the lower cover, the USB interface being provided on one end of the snap-fit position of the upper cover with the lower cover, the SD card cover being pivotally connected on one end of the lower cover provided with the USB interface, the SD card which is fixed within the lower cover being provided at inner side of the SD card cover, and the SD card being clamped on a SD card fixing seat which is fixed on a lower side of the main circuit board within the lower cover, and the SD card joint being provided on the other end of the snap-fit position of the upper cover with the lower cover.

2. The detachable storage device as claimed in claim 1, wherein the SD card joint is fixed on an upper side of a sliding block which is slidably connected on a SD card joint sliding seat, the SD card joint sliding seat being fixed within the lower cover, and a lower side of the sliding block extending through a sliding groove on the surface of the lower cover.

3. The detachable storage device as claimed in claim 2, wherein a SD card joint spring is arranged between the sliding block and one end of the lower cover provided with the SD card joint, a buckle strip being provided on the sliding block, and a buckle groove being opened on the lower cover corresponding to the buckle strip.

4. The detachable storage device as claimed in claim 1, wherein the USB interface is fixed on a lower side of the sliding block seat which is slidably connected on a USB interface fixing seat fastened or locked on the upper cover, a USB interface sliding block being fixed on an upper side of a lock catch cover body, and the USB interface sliding block extending through the USB interface fixing seat and extending out from a sliding groove on the surface of the upper cover.

5. The detachable storage device as claimed in claim 4, wherein a locking seat is arranged between the USB interface fixing seat and the upper cover, and a groove being provided on the locking seat for locking the USB interface sliding block.

6. The detachable storage device as claimed in claim 5, wherein a USB interface spring is arranged between the USB interface fixing seat and an inner side of one end of the upper cover away from the USB interface.
